(19) United States
(12) Patent Application Publication
(10) Pub. No.: US 2016/0236218 A1
(43) Pub. Date: Aug. 18, 2016

(54) DISPENSER FOR DISPENSING A FLOWABLE SUBSTANCE

(71) Applicant: COLGATE-PALMOLIVE COMPANY, New York, NY (US)

(72) Inventor: Kiat-Cheong TOH, Forest Hills, NY (US)

(21) Appl. No.: 15/024,416

(22) PCT Filed: Sep. 24, 2013
(86) PCT No.: PCT/US2013/061332

§ 371 Date: Mar. 24, 2016

(51) Int. Cl. B05B 11/00; A47K 5/12

(52) U.S. Cl. CPC B05B 11/306; A47K 5/1211; B05B 11/3009; B05B 11/0056

(57) ABSTRACT

A dispenser (3) for dispensing a flowable substance, comprising: a body having at least one contact portion (15) lying in a first plane for supporting the dispenser on a horizontal surface and a container (6) defining a chamber for storing a flowable substance, the chamber having a floor, a first portion of the floor at a first side portion of the chamber lying in a second plane parallel to the first plane, and a second portion of the floor at a second side portion of the chamber lying in a third plane parallel to the first plane, wherein the second plane lies between the first and third planes; and a pump system (20) comprising a pump for pumping the flowable substance from the chamber to an exterior of the container, and a tube (24) extending from the pump and having an opening within the chamber between the second and third planes.

### BACKGROUND

The present invention relates to dispensers for dispensing a flowable substance, for example a fluid personal care product such as a liquid hand soap.

It is known to provide a flowable substance, such as a liquid hand soap, a dentifrice, a hair care product, or a body wash, in the chamber of a dispenser having a pump for dispensing the flowable substance by pumping the flowable substance from the chamber to an exterior of the container. However, typically it is difficult or impossible to extract all of the flowable substance from the chamber using the pump, meaning that a residual volume of the flowable substance in the chamber is wasted. Also, typically a handle of the pump is provided uppermost on the dispenser, which makes stacking of multiple ones of the dispenser impossible or, at best, unstable.

There is a need for a dispenser that is usable to extract more, preferably all, of a flowable substance in a chamber thereof. There also is a need for a dispenser having a pump assembly, wherein multiple ones of the dispenser are stackable.

### BRIEF SUMMARY

An embodiment of the present invention provides a dispenser for dispensing a flowable substance, comprising: a body having at least one contact portion lying in a first plane for supporting the dispenser on a horizontal surface and a container defining a chamber for storing a flowable substance, the chamber having a floor, a first portion of the floor at a first side portion of the chamber lying in a second plane parallel to the first plane, and a second portion of the floor at a second side portion of the chamber lying in a third plane parallel to the first plane, wherein the second plane lies between the first and third planes; and a pump system comprising a pump for pumping the flowable substance from the chamber to an exterior of the container, and a tube extending from the pump and having an opening within the chamber between the second and third planes.

Optionally, at least a portion of the floor between the first and second portions is inclined relative to the first plane.

Optionally, the floor is stepped between the first and second portions.

Optionally, the first portion of the floor is the portion of the floor closest to the first plane.

Optionally, the chamber is elongate in a direction parallel to the first plane. Further optionally, the direction parallel to the first plane extends between the first and second side portions of the chamber.

Optionally, the tube extends in a direction perpendicular to the first plane.

Optionally, the opening is an open end of the tube.

Optionally, the open end of the tube extends below the third plane.

Optionally, the dispenser comprises an aperture through which a flowable substance is introducible into the chamber in parallel to the pump system. Further optionally, the container comprises a lid by which the aperture is selectively blockable.

Optionally, the aperture and the pump system are spaced apart in the direction parallel to the first plane.

Optionally, an uppermost portion of the container lies in a fourth plane parallel to the first plane, and the pump system comprises a handle movable by a user to operate the pump, wherein the handle is lockable at a position relative to the container with an uppermost portion of the handle lying in the fourth plane.

Another embodiment of the present invention provides a dispenser for dispensing a flowable substance, comprising: a body having at least one contact portion lying in a first plane for supporting the dispenser on a horizontal surface and a container defining a chamber for storing a flowable substance, wherein an uppermost portion of the container lies in a second plane parallel to the first plane; and a pump system comprising a pump for pumping the flowable substance from the chamber to an exterior of the container, and a handle movable by a user to operate the pump, wherein the handle is lockable at a position relative to the container with an uppermost portion of the handle lying in the second plane.

Optionally, when locked at the position relative to the container, the handle is immovable relative to the container in a direction towards the first plane.

Optionally, when locked at the position relative to the container, the handle is immovable relative to the container in a direction away from the first plane.

Optionally, when unlocked relative to the container, the handle is movable relative to the container towards and away from the first plane to operate the pump.

Optionally, the handle is lockable and/or unlockable by rotating the handle relative to the container about an axis that is perpendicular to the first plane.

Optionally, the handle is locked at the position relative to the container with the uppermost portion of the handle lying in the second plane.

Optionally, the container comprises an aperture through which a flowable substance is introducible into the chamber in parallel to the pump system. Further optionally, the container comprises a lid comprising the uppermost portion of the container and by which the aperture is selectively blockable.

Optionally, the chamber is elongate in a direction parallel to the first plane.

Optionally, the aperture and the pump system are spaced apart in the direction parallel to the first plane.

Optionally, the chamber has a floor, a first portion of the floor at a first side portion of the chamber lying in a third plane parallel to the first plane, and a second portion of the floor at a second side portion of the chamber lying in a fourth plane parallel to the first plane, wherein the third plane lies between the first and fourth planes.

Optionally, the pump system comprises a tube extending from the pump and having an opening within the chamber between the third and fourth planes. Further optionally, the tube extends in a direction perpendicular to the first plane.

Optionally, at least a portion of the floor between the first and second portions is inclined relative to the first plane.

Optionally, the floor is stepped between the first and second portions.

Optionally, the direction parallel to the first plane extends between the first and second side portions of the chamber.

Optionally, the container comprises a first portion at least partly defining the chamber and having an open end, and a second portion attached to the open end of the first portion, wherein the first and second portions of the container are non-unitary, wherein the second portion comprises an orifice, and wherein the pump system is at least partially disposed in the orifice. Further optionally, the first portion of the container defines the floor of the chamber and the second portion of the container partly defines the chamber.

Optionally, the first portion of the container is transparent.

Optionally, the second portion of the container is opaque.

Optionally, the second portion of the container comprises the aperture.

Optionally, the dispenser comprises the flowable substance in the chamber.

Optionally, the flowable substance is a fluid personal care product. Further optionally, the fluid personal care product is selected from a liquid hand soap, a dentifrice, a hair care product, and a body wash.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a perspective view of a dispenser according to an exemplary embodiment of the present invention;

FIG. 2 shows a side view of the dispenser of FIG. 1;

FIG. 3 shows a side view of a dispenser according to another exemplary embodiment of the present invention;

FIG. 4 shows a side view of a dispenser according to a further exemplary embodiment of the present invention;

FIG. 5 shows a side view of two of the dispensers shown in FIG. 4 stacked one on top of the other with a separator therebetween; and

FIG. 6 shows an exploded perspective view of the components of the dispenser shown in FIG. 4.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

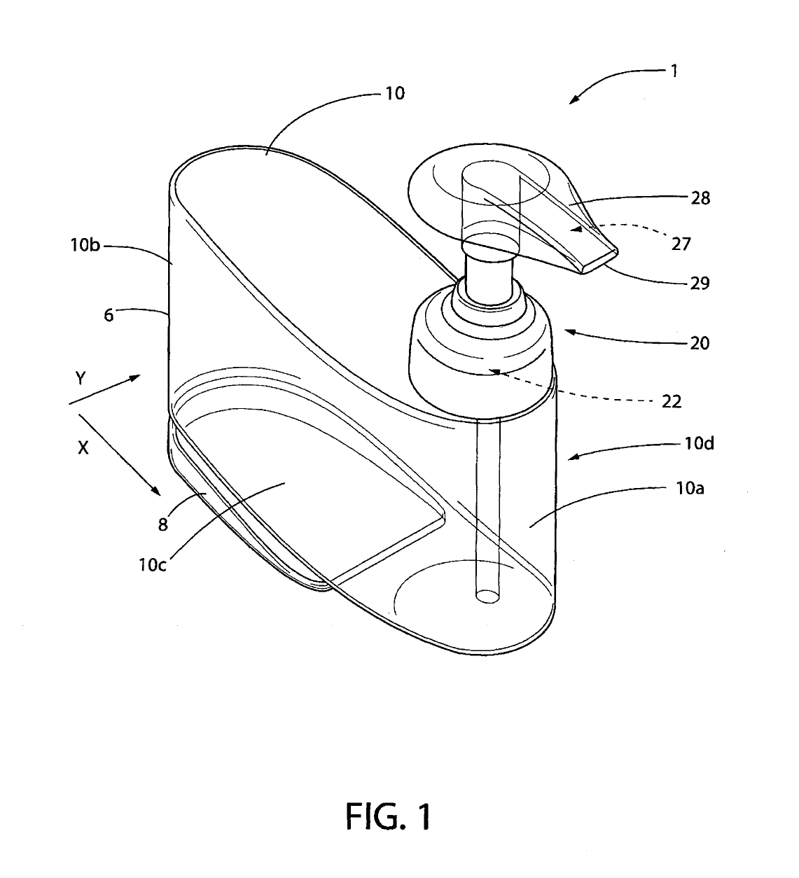

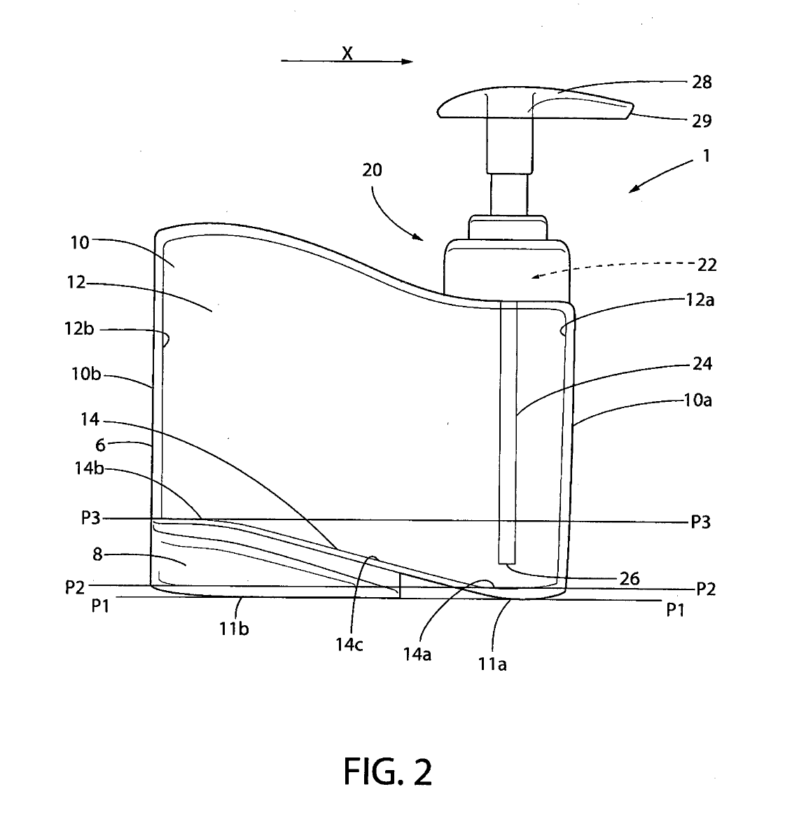

FIGS. 1 and 2 show a dispenser 1, for dispensing a flowable substance, of an exemplary embodiment of the present invention. The dispenser 1 comprises a body 6, which comprises a base 8 and a container 10. In this embodiment, the base 8 is unitary with, i.e. integrally formed with, the container 10, but in other embodiments the base 8 and container 10 may be separately formed and connected to each other after their formation. The body 6 has a plurality of contact portions 11a, 11b lying in a first plane P₁-P₁ for supporting the body 6 and the rest of the dispenser 1 on a horizontal surface. In the illustrated embodiment, one 11a of the contact portions is a planar portion of the container 10 and the other 11b of the contact portions is planar portion of the base 8.

In a variation to the illustrated embodiment, the container 10 has one or more non-planar contact portions lying in the first plane P₁-P₁, such as one or more point apexes or line apexes that are each a portion of a curved or non-planar surface of the container 10, yet the combination of the contact portion(s) of the container 10 and the contact portion(s) of the base 8 enables the body 6 to be supported on a horizontal surface. In a variation to the illustrated embodiment, the base 8 has one or more non-planar contact portions lying in the first plane P₁-P₁, such as one or more point apexes or line apexes that are each a portion of a curved or non-planar surface of the base 8, yet the combination of the contact portion(s) of the container 10 and the contact portion(s) of the base 8 enables the body 6 to be supported on a horizontal surface.

In a further variation to the illustrated embodiment, the base 8 has one or more contact portions lying in the first plane P₁-P₁ and no part of the container 10 lies in the first plane P₁-P₁. For example, the base 8 may have a flat underside for contacting the horizontal surface or may have only one annular contact portion for contacting the horizontal surface. In such variations, the base 8 may extend for at least a majority, optionally all, of a width of the dispenser 1 in a first direction X. Other configurations of contact portion(s) will be apparent to the skilled person.

The container 10 has first, second, third and fourth sides 10a, 10b, 10c, 10d extending upwardly in a direction away from the first plane P₁-P₁ and defining or delimiting a chamber 12 in the container 10 for storing a flowable substance, i.e. a substance that is able to flow at room temperature and atmospheric pressure. Herein, by “room temperature” it is meant a temperature of 20 to 25 degrees Celsius, and by “atmospheric pressure” it is meant a pressure of 101 kPa. The first and second sides 10, 10b are opposed, and the third and fourth sides 10c, 10d are opposed.

The chamber 12 has a floor 14 at the end of the chamber 12 closest to the first plane P₁-P₁. The floor 14 has a first portion 14a at a first side portion 12a of the chamber 12 and a second portion 14b at an opposed second side portion 12b of the chamber 12. The first side portion 12a of the chamber 12 extends inwardly from the first side 10a of the container 10, and the second side portion 12b of the chamber 12 extends inwardly from the second side 10b of the container 10. The chamber 12 can be considered to have a width in the first direction X. The first side portion 12a of the chamber 12 preferably extends from the first side 10a of the container 10 and towards the second side 10b of the container 10 over a distance that is no more than 50% of the width of the chamber 12, and more preferably less than 30% of the width of the chamber 12. Similarly, the second side portion 12b of the chamber 12 preferably extends from the second side 10b of the container 10 and towards the first side 10a of the container 10 over a distance that is no more than 50% of the width of the chamber 12, and more preferably less than 30% of the width of the chamber 12.

The first portion 14a of the floor 14 lies in a second plane P₂-P₂ parallel to the first plane P₁-P₁, and the second portion 14b of the floor 14 lies in a third plane P₃-P₃ parallel to the first plane P₁-P₁. The second plane P₂-P₂ lies between the first and third planes P₁-P₁, P₃-P₃. The first portion 14a of the floor 14 is the portion of the floor 14 closest to the first plane P₁-P₁. A portion 14c of the floor 14 between the first and second portions 14a, 14b of the floor 14 is inclined relative to (i.e. is non-parallel to) the first plane P₁-P₁, so as to connect the first and second portions 14a, 14b of the floor 14. In a variation to the illustrated embodiment, the floor 14 may be stepped (i.e. include steps therein) between the first and second portions 14a, 14b of the floor 14, so as to connect the first and second portions 14a, 14b of the floor 14. In other embodiments, the floor 14 may include a combination of stepped and inclined portion(s) between the first and second portions 14a, 14b.

The area of the first portion 14a of the floor 14 may be less than 50% of the total area of the floor 14, more preferably between 1% and 30% of the total area of the floor 14, more preferably between 5% and 25% of the total area of the floor 14, and most preferably between 5% and 15% of the total area of the floor 14. In the illustrated embodiment, each of the first and second portions 14a, 14b of the floor 14 is substantially planar and parallel to the first plane P₁-P₁. In variations to the illustrated embodiment, the second portion 14b of the floor 14 is planar or non-planar and lies in the third plane P₃-P₃ but is part of a portion of the floor 14 that is non-parallel to the first plane P₁-P₁ for encouraging flow of the flowable substance within the chamber 12 towards the first portion 14a of the floor 14 under the influence of gravity. In some variations to the illustrated embodiment, the first portion 14a of the floor 14 is planar or non-planar and lies in the second plane P₂-P₂ but is part of a portion of the floor 14 that is non-parallel to the first plane P₁-P₁.

In the illustrated embodiment, the container 10 is transparent. The transparent nature of the container 10 allows a user to see how much flowable substance remains in the chamber 12 during use. In variations to this embodiment, the container 10 may be partially, or fully, translucent or opaque.

As will be appreciated from consideration of FIG. 1, the container 10 and the chamber 12 therein are each elongate in the first direction X that is parallel to the first plane P₁-P₁ and that extends between the first and second side portions 12a, 12b of the chamber 12 and between the first and second sides 10a, 10b of the container 10. That is, the container 10 and the chamber 12 therein each has a major axis extending in the first direction X and a minor axis extending in a second direction Y perpendicular to the first direction X and parallel to the first plane P₁-P₁. The first and second sides 10a, 10b of the container 10 are opposed and spaced apart in the first direction X, while the third and fourth sides 10c, 10d of the container 10 are opposed and spaced apart in the second direction Y. Accordingly, the first and second sides 10a, 10b of the container 10 are minor sides of the container, and the third and fourth sides 10c, 10d of the container 10 are major sides of the container 10. The enlarged nature of the third and fourth sides 10c, 10d relative to the first and second sides 10a, 10b provides space on the third and fourth sides 10c, 10d for including advertising material and/or indicia of the contents of the container 10, while maintaining a narrow footprint of the entire container 10 and dispenser 1 as a whole. Accordingly, the dispenser 1 would not occupy a large area of a work surface when in use, or of a shelf when being marketed in a shop. One of the third and fourth sides 10c, 10d may be intended to face customers on a shelf in a shop or store, while the first face 10a may be intended to face a user when the dispenser 1 is present on a work surface.

The dispenser 1 further comprises a pump system 20 comprising a pump 22 for pumping the flowable substance from the chamber 12 to an exterior of the container 10, i.e. to an exterior of the dispenser 1. The pump 22 may be of any suitable format known in the art, and will not be described herein in more detail. In addition to the pump 22, the pump system 20 comprises a tube 24 extending from the pump 22 in a direction perpendicular to the first plane P₁-P₁ and having an opening 26, in the form of an open end of the tube 24, within the chamber 12 between the second and third planes P₂-P₂, P₃-P₃. Preferably, as in the illustrated embodiment, the opening 26 of the tube is closer to the second plane P₂-P₂ than to the third plane P₃-P₃. In variations to the illustrated embodiment, the opening 26 of the tube 24 within the chamber 12 between the second and third planes P₂-P₂, P₃-P₃ may take the form of an opening in a circumferential wall of the tube 24. In some such variations, the tube 24 has a closed end, while in other such variations the tube 24 also has an open end, which open end may not be within the chamber 12 between the second and third planes P₂-P₂, P₃-P₃.

In the illustrated embodiment, the tube 24 is a dip tube 24 that is not unitary with the container 10, but in other embodiments the tube may be defined by, integral with, or otherwise molded into, a side of the container 10, such as the first side 10a. Such alternative constructions still are considered a tube.

The pump system 20 also comprises a handle 28 having an outlet 29, through which outlet 29 the flowable substance is dispensable, and an internal passageway 27 connecting the pump 22 to the outlet 29. The handle 28 is movable by a user relative to the container 10 to operate the pump 22, thereby to pump the flowable substance from the chamber 12 to the exterior of the container 10 via the internal passageway 27 and the outlet 29 in order to dispense the flowable substance. More specifically, movement of the handle 28 relative to the container 10 in a direction towards and away from the first plane P₁-P₁ and in a direction perpendicular to the first plane P₁-P₁ causes the operation of the pump 22 and dispensing of the flowable substance through the internal passageway 27 and the outlet 29.

The handle 28 is lockable relative to the container 10, to cause the handle 28 to become immovable relative to the container 10 in the direction towards and away from the first plane P₁-P₁, by rotating the handle 28 relative to the container 10 in a first rotational direction about an axis that is perpendicular to the first plane P₁-P₁. Once locked relative to the container 10, the handle 28 is unlockable relative to the container 10 by rotating the handle 28 relative to the container 10 in a second rotational direction about the axis, wherein the second rotational direction is opposite to the first rotational direction. When unlocked, the handle 28 and container 10 are relatively positioned as shown in FIGS. 1 and 2. Once unlocked relative to the container 10, the handle 28 is again moveable relative to the container 10 in the direction towards and away from the first plane P₁-P₁ and in the direction perpendicular to the first plane P₁-P₁ to cause the operation of the pump 22. In variations to this embodiment, the handle 28 may be lockable relative to the container 10 by a different mechanism. In other variations to this embodiment, the handle 28 may not be lockable relative to the container 10.

As a result of the first portion 14a (i.e. the portion of the floor 14 closest to the first plane P₁-P₁) of the floor 14 lying in the second plane P₂-P₂, when the flowable substance in the chamber 12 is nearly exhausted the residual volume of the flowable substance in the chamber 12 tends to collect on the first portion 14a. As a result of the opening 26 of the tube 24 being within the chamber 12 and between the second and third planes P₂-P₂, P₃-P₃, the pump assembly 20 is usable to extract most, and preferably all, of the flowable substance from the chamber 12.

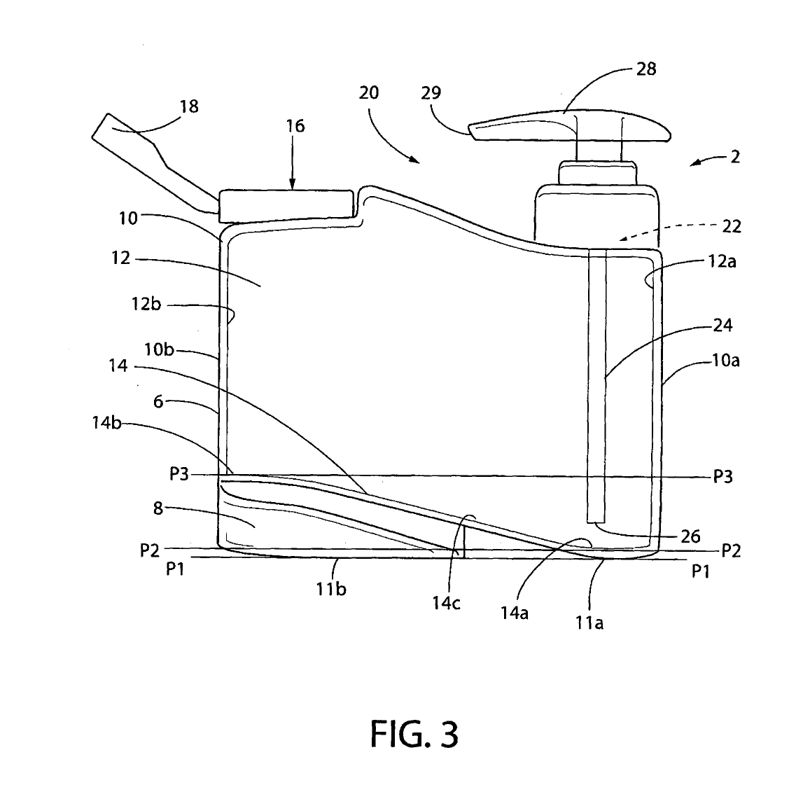

FIG. 3 shows another dispenser 2, for dispensing a flowable substance, of an exemplary embodiment of the present invention. Like components in FIGS. 1 to 3 have like reference numerals and will not be described again for conciseness.

The dispenser 2 of FIG. 3 is the same as the dispenser 1 of FIGS. 1 and 2, except that the container 10 of FIG. 3 comprises an aperture 16 through which a flowable substance is introducible into the chamber 12 from the exterior of the container 10 and dispenser 2. The aperture 16 is in parallel to the pump system 20. That is, there are two flow paths in parallel between the chamber 12 and the exterior of the container 10, one via the aperture 16 and the other via the pump system 20 and outlet 29 thereof. Accordingly, it is possible to introduce flowable substance into the chamber 12 via the aperture 16 once the supply of flowable substance in the chamber 12 has been exhausted, and without needing to disconnect the pump 20 assembly from the container 10. The aperture 16 and the pump system 20 are spaced apart in the first direction X that is parallel to the first plane P₁-P₁.

The container 10 of the dispenser 2 also comprises a lid 18 by which the aperture 16 is selectively blockable. In FIG. 3, the lid 18 is shown at a first position relative to the rest of the container 10 and the chamber 12, at which first position the lid 18 does not block the aperture 16, so that the chamber 12 is in fluid communication with the exterior of the container 10 and dispenser 2 via the aperture 16. The lid 18 is movably connected to the rest of the container 10 by a hinge. By rotating the lid 18 relative to the rest of the container 10 about the hinge, the lid 18 is movable to a second position at which the lid 18 blocks the aperture 16, thus preventing fluid communication between the chamber 12 and the exterior of the container 10 and dispenser 2. In variations to the illustrated embodiment, the lid 18 may be movably connected to the rest of the container 10 by other than a hinge, or may be detachable from the rest of the container 10. The lid 18 may be movable to its first position relative to the rest of the container 10 when the dispenser 2 is on the shelf of a store or shop, to permit consumers to sample a scent of the flowable substance before purchase or use.

In FIG. 3, the handle 28 is shown at its locked position relative to the container 10. The dispenser 2 of FIG. 3 has the same relationship between the floor 14 of the chamber 12 and the position of the opening 26 of the tube 24 as the dispenser 1 in FIGS. 1 and 2. Accordingly, when the handle 28 is unlocked relative to the container 10 in the same manner as the handle 28 of the dispenser 1 of FIGS. 1 and 2 is unlockable relative to the container 10 of FIGS. 1 and 2, the pump assembly 20 of the dispenser 2 of FIG. 3 is usable to extract most, and preferably all, of the flowable substance from the chamber 12 in the same manner as the pump assembly 20 of the dispenser 1 of FIGS. 1 and 2.

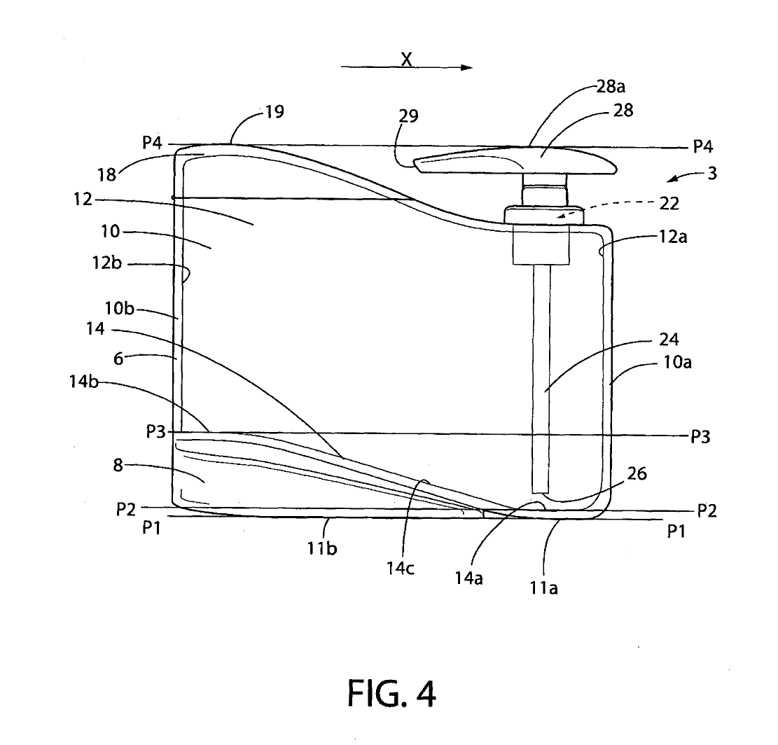

FIG. 4 shows another dispenser 3, for dispensing a flowable substance, of an exemplary embodiment of the present invention. Like components in FIGS. 1 to 4 have like reference numerals and will not be described again for conciseness.

The dispenser 3 of FIG. 4 is the same as the dispenser 2 of FIG. 3 except that (a) an uppermost portion 19 of the container 10 of FIG. 4 lies in a fourth plane P₄-P₄ parallel to the first plane P₁-P₁, and (b) the handle 28 of FIG. 4 has an uppermost portion 28a which, when the handle 28 is locked relative to the container 10 to cause the handle 28 to become immovable relative to the container 10 in the direction towards and away from the first plane P₁-P₁ (as shown in FIG. 4), also lies in the fourth plane P₄-P₄.

The uppermost portion 19 of the container 10 is that part of the container 10 furthest from the first plane P₁-P₁. In the illustrated embodiment, the uppermost portion 19 of the container 10 comprises a planar area of a top surface of the lid 18 of the container 10. In variations to the illustrated embodiment, the uppermost portion 19 of the container 10 comprises one or more point apexes or line apexes of a top surface of the container 10. For example, when the uppermost portion 19 of the container 10 is part of a curved top surface of the container 10, the fourth plane P₄-P₄ would be tangential to the curved top surface of the container 10 and thus only a line apex of the curved top surface of the container 10 would lie in the fourth plane P₄-P₄. In a variation to the embodiment shown in FIG. 4, the lid 18 is omitted and the uppermost portion 19 of the container 10 is thus not comprised in the lid 18 but is comprised in the rest of the container 10.

The uppermost portion 28a of the handle 28 is that part of the handle 28 furthest from the first plane P₁-P₁. In the illustrated embodiment, the uppermost portion 28a of the handle 28 comprises a planar area of a top surface of the handle 28. In variations to the illustrated embodiment, the uppermost portion 28a of the handle 28 comprises one or more point apexes or line apexes of a top surface of the handle 28. For example, when the uppermost portion 28a of the handle 28 is part of a curved top surface of the handle 28, the fourth plane P₄-P₄ would be tangential to the curved top surface of the handle 28 and thus only a line apex of the curved top surface of the handle 28 would lie in the fourth plane P₄-P₄.

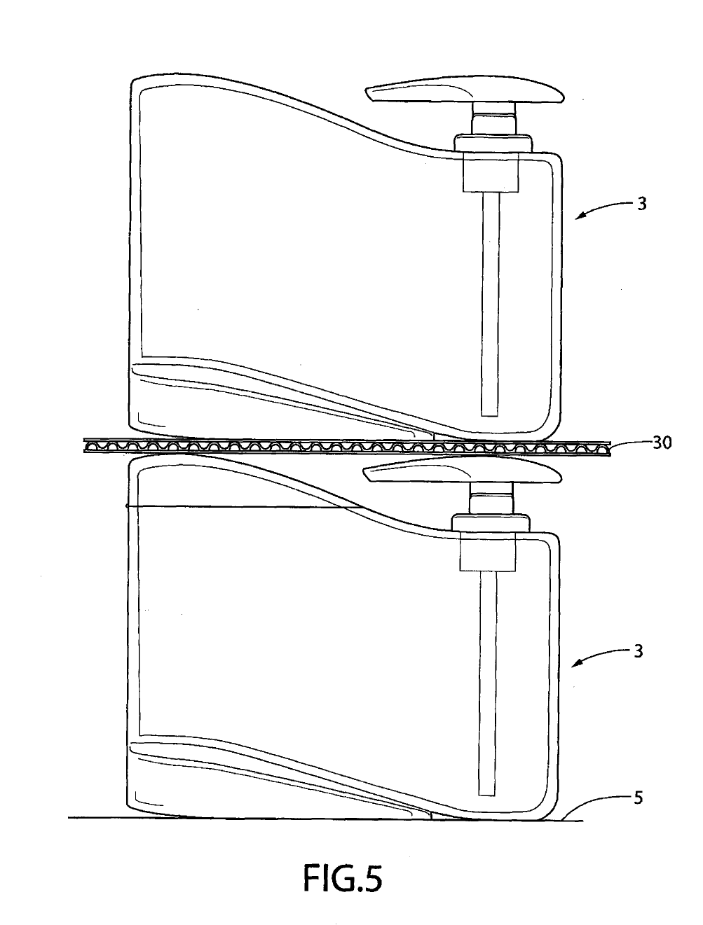

As a result of the uppermost portions 19, 28a of the container 10 and the handle 28 both lying in the fourth plane P₄-P₄ when the handle 28 is locked relative to the container 10 to cause the handle 28 to become immovable relative to the container 10 in the direction towards and away from the first plane P₁-P₁, the uppermost portions 19, 28a form elements upon which another article, such as another of the dispensers 3, may be supported when the dispenser 3 is supported on a horizontal surface. For example, as shown in FIG. 5, two of the dispensers 3 shown in FIG. 4 may be stacked one on top of the other, optionally with a separator 30 such as a layer of cardboard therebetween, with the lower dispenser 3 being supported on a horizontal surface 5, the separator 30 contacting the uppermost portions 19, 28a of the container 10 and the handle 28, and the upper dispenser 3 supporting on the separator 30.

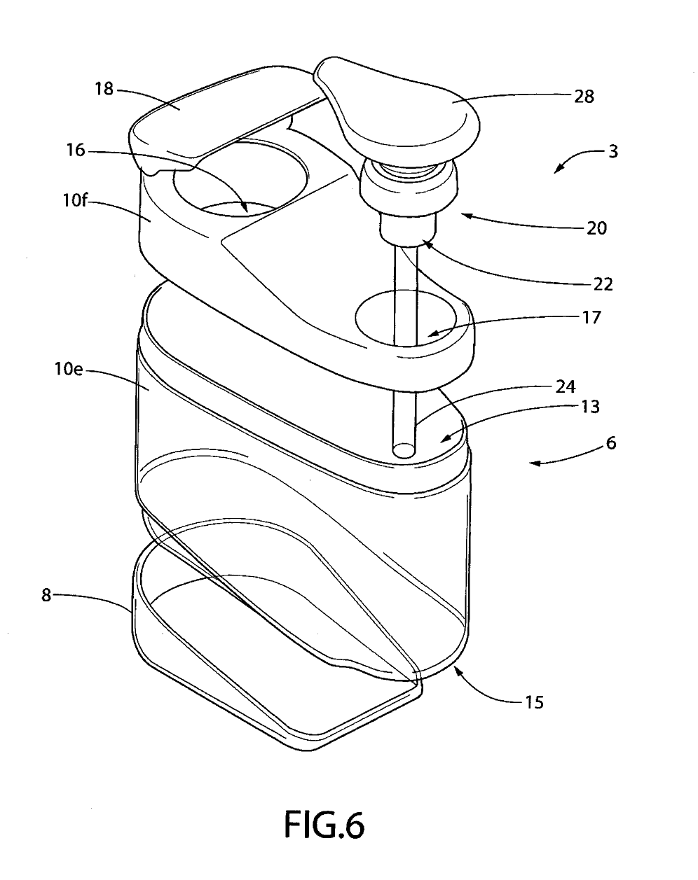

As shown in FIG. 6, the container 10 of the dispenser of FIG. 4 comprises first and second non-unitary, or non-integral, portions 10e, 10f. Each of the first and second portions 10e, 10f of the container 10 partly defines the chamber 12, with the first portion 10e of the container 10 defining the floor 14 of the chamber 12. The first portion 10e of the container 10 further has an open end 13, through which the chamber 12 is in fluid communication with the exterior of the container 10 when the dispenser 3 is in the unassembled state of FIG. 6. The open end 13 extends for the entire width of the chamber 12 in the first direction X. Moreover, the open end 13 extends for the whole dimension of the chamber 12 in the second direction Y perpendicular to the first direction X.

During assembly of the dispenser 3, the second portion 10f is attached to the open end 13 of the first portion 10e so that, when the dispenser 3 is fully assembled, the second portion 10f of the container 10 obstructs the open end 13 of the first portion 10e of the container 10. The second portion 10f of the container 10 comprises an orifice 17 extending therethrough, within which orifice 17 the pump system 20 is partially disposed so as to extend through the orifice 17. The second portion 10f of the container 10 also comprises the aperture 16 extending through the second portion 10f in parallel to the orifice 17.

In the illustrated embodiment, the lid 18 is comprised in the second portion 10f of the container 10. The lid 18 may be unitary with the rest of the second portion 10f of the container 10, and for example connected to the rest of the second portion 10f of the container 10 by a living hinge, or the lid 18 may be non-unitary with, but connected to, the rest of the second portion 10f of the container 10.

In the illustrated embodiment, the first portion 10e of the container 10 is transparent and the second portion 10f of the container 10 is opaque. Since the first portion 10e of the container 10 lacks the orifice 17 and aperture 16, the first portion 10e of the container 10 is simple to manufacture and lends itself to manufacture e.g. by blow molding or injection molding a transparent material.

In assembling the dispenser 3 of FIGS. 4 and 6, the second portion 10f of the container 10 is attached to the open end 13 of the first portion 10e of the container. The attachment may be e,g, by adhesion, snap-fit, or another mechanism or combination of the same. Afterwards, before, or during attachment of the second portion 10f to the first portion 10e, the base 8 is attached to a bottom end 15 of the first portion 10e of the container 10, which bottom end 15 is at an opposite end of the first portion 10e of the container 10 to the open end 13. The attachment may be e,g, by adhesion, snap-fit, or another mechanism or combination of the same. The pump assembly 20 is then inserted into the orifice 17 and attached to the container 10, e.g. through a snap-fit connection (not shown) between the pump assembly 20 and the second portion 10f of the container 10. The flowable substance is introduced into the chamber 12 from the exterior of the container 10 via the aperture 16, and then the lid 18 is moved to its second position to block the aperture 16. Alternatively or additionally, the flowable substance may be introduced into the chamber 12 from the exterior of the container 10 via the orifice 17, prior to insertion of the pump assembly 20 into the orifice 17.

In the embodiment of FIG. 4 the handle 28 is unlockable relative to the container 10 in the same manner as the handle 28 of the dispenser 1 of FIGS. 1 and 2 is unlockable relative to the container 10 of FIGS. 1 and 2 by relative rotation of the handle 28 and the container 10. However, in the embodiment of FIG. 4, after unlocking the handle 28, the handle 28 is biased upwards a little by a resilient device (not shown) of the pump assembly 20 so that the fourth plane P₄-P₄ lies between the first plane P₁-P₁ and the uppermost portion 28a of the handle 28. The handle 28 then is movable relative to the container 10 towards and away from the first plane P₁-P₁ to operate the pump 22.

In variations to the illustrated arrangement of FIG. 5, the separator 30 may be omitted and the upper dispenser 3 may contact directly the uppermost portions 19, 28a of the container 10 and the handle 28 of the lower dispenser 3 while still being stably supported.

In each of the dispensers 1, 2, 3 described above, the handle 28 is lockable at a position relative to the container 10, to cause the handle 28 to become immovable relative to the container 10 in the direction towards and away from the first plane P₁-P₁, by rotating the handle 28 relative to the container 10 in a first rotational direction about an axis that is perpendicular to the first plane P₁-P₁. In respective variations to these embodiments, the handle 28 may be lockable at a position relative to the container 10 by some other mechanism to cause the handle 28 to become immovable relative to the container 10 in the direction towards and away from the first plane P₁-P₁.

In each of the dispensers 1, 2, 3 described above, the chamber 12 is empty but fillable with a flowable substance. In variations to these embodiments, a flowable substance may be stored in the respective chambers 12. The flowable substance may be a fluid personal care product, such as any of a liquid hand soap, a dentifrice, a hair care product, a body wash, or another fluid personal care product. Alternatively, the flowable substance may be a home care product, such as a floor cleaner or a surface cleaner.

1. A dispenser for dispensing a flowable substance, comprising:
a body having at least one contact portion lying in a first plane for supporting the dispenser on a horizontal surface and a container defining a chamber for storing a flowable substance, the chamber having a floor, a first portion of the floor at a first side portion of the chamber lying in a second plane parallel to the first plane, and a second portion of the floor at a second side portion of the chamber lying in a third plane parallel to the first plane, wherein the second plane lies between the first and third planes; and
a pump system comprising a pump for pumping the flowable substance from the chamber to an exterior of the container, and a tube extending from the pump and having an opening within the chamber between the second and third planes.

2. The dispenser of claim 1, wherein at least a portion of the floor between the first and second portions is inclined relative to the first plane, and/or wherein the floor is stepped between the first and second portions.

3. The dispenser of claim 1, wherein the first portion of the floor is the portion of the floor closest to the first plane.

4. The dispenser of claim 1, wherein the chamber is elongate in a direction parallel to the first plane.

5. The dispenser of claim 4, wherein the direction parallel to the first plane extends between the first and second side portions of the chamber.

6. The dispenser of claim 1, wherein the tube extends in a direction perpendicular to the first plane.

7. The dispenser of claim 1, wherein the opening is an open end of the tube, optionally wherein the open end of the tube extends below the third plane.

8. The dispenser of claim 1, wherein the container comprises an aperture through which the flowable substance is introducible into the chamber in parallel to the pump system, optionally wherein the container comprises a lid by which the aperture is selectively blockable.

9. The dispenser of claim 8, when dependent on any one of claims 4 to 7, wherein the aperture and the pump system are spaced apart in the direction parallel to the first plane.

10. The dispenser of claim 1, wherein an uppermost portion of the container lies in a fourth plane parallel to the first plane, and wherein the pump system comprises a handle movable by a user to operate the pump, wherein the handle is lockable at a position relative to the container with an uppermost portion of the handle lying in the fourth plane.

11. A dispenser for dispensing a flowable substance, comprising:
a body having at least one contact portion lying in a first plane for supporting the dispenser on a horizontal surface and a container defining a chamber for storing a flowable substance, wherein an uppermost portion of the container lies in a second plane parallel to the first plane; and
a pump system comprising a pump for pumping the flowable substance from the chamber to an exterior of the container, and a handle movable by a user to operate the pump, wherein the handle is lockable at a position relative to the container with an uppermost portion of the handle lying in the second plane.

12. The dispenser of claim 11 wherein, when locked at the position relative to the container, the handle is immovable relative to the container in a direction towards the first plane, optionally wherein, when locked at the position relative to the container, the handle is immovable relative to the container in a direction away from the first plane.

13. The dispenser of claim 11 wherein, when unlocked relative to the container, the handle is movable relative to the container towards and away from the first plane to operate the pump.

14. The dispenser of claim 11, wherein the handle is lockable and/or unlockable by rotating the handle relative to the container about an axis that is perpendicular to the first plane.

15. The dispenser of claim 11, wherein the handle is locked at the position relative to the container with the uppermost portion of the handle lying in the second plane.

16. The dispenser of claim 11 any one of claims 11 to 15,
wherein the container comprises an aperture through which a flowable substance is introducible into the chamber in parallel to the pump system, optionally wherein the container comprises a lid comprising the uppermost portion of the container and by which the aperture is selectively blockable.

17. The dispenser of claim 11, wherein the chamber is elongate in a direction parallel to the first plane.

18. The dispenser of claim 17, wherein the aperture and the pump system are spaced apart in the direction parallel to the first plane.

19. The dispenser of claim 11, wherein the chamber has a floor, a first portion of the floor at a first side portion of the chamber lying in a third plane parallel to the first plane, and a second potion of the floor at a second side portion of the chamber lying in a fourth plane parallel to the first plane, wherein the third plane lies between the first and fourth planes.

20. The dispenser of claim 19, wherein the pump system comprises a tube extending from the pump and having an opening within the chamber between the third and fourth planes, optionally wherein the tube extends in a direction perpendicular to the first plane.

21. The dispenser of claim 19, wherein at least a portion of the floor between the first and second portions is inclined relative to the first plane.

22. The dispenser of claim 19, wherein the floor is stepped between the first and second portions.

23. The dispenser of claim 19, when dependent on claim 17, wherein the direction parallel to the first plane extends between the first and second side portions of the chamber.

24. The dispenser of claim 11, wherein the container comprises a first portion at least partly defining the chamber and having an open end, and a second portion attached to the open end of the first portion, wherein the first and second portions of the container are non-unitary, wherein the second portion comprises an orifice, and wherein the pump system is at least partially disposed in the orifice.

25. The dispenser of claim 24, wherein the first portion of the container defines the floor of the chamber and the second portion of the container partly defines the chamber.

26. The dispenser of claim 24, wherein the first portion of the container is transparent and/or wherein the second portion of the container is opaque.

27. The dispenser of claim 24, when dependent on any one of claims 8, 9 and 16, wherein the second portion of the container comprises the aperture.

28. The dispenser of claim 11 comprising the flowable substance in the chamber.

29. The dispenser of claim 11, wherein the flowable substance is a fluid personal care product, optionally wherein the fluid personal care product is selected from a liquid hand soap, a dentifrice, a hair care product, and a body wash.
